(19) United States
(12) Patent Application Publication
(10) Pub. No.: US 2026/0159355 A1
(43) Pub. Date: Jun. 11, 2026

(54) ELEVATOR ROLLER PRESSURE ADJUSTMENT ASSEMBLY AND ADJUSTMENT METHOD, ELEVATOR GUIDE SHOE AND ELEVATOR SYSTEM

(71) Applicant: Otis Elevator Company, Farmington, CT (US)

(72) Inventors: Yingjin Zhang, Shanghai (CN); ZhenXing Peng, Shanghai (CN); Yuancheng You, Shanghai (CN)

(21) Appl. No.: 19/391,508

(22) Filed: Nov. 17, 2025

(30) Foreign Application Priority Data
Dec. 5, 2024 (CN) 202411785732.6

(51) Int. Cl. B66B 7/04

(52) U.S. Cl. CPC B66B 7/046; B66B 7/047

(57) ABSTRACT

An elevator roller pressure adjustment assembly includes: a contact member, fixed relative to at least one roller configured on an elevator car or counterweight, the roller being in rolling contact with an elevator guide rail and defining a running trajectory of the elevator car or counterweight along the elevator guide rail during normal operation of an elevator system; and a cooperating member, mounted at a preset position on the elevator guide rail and arranged outside the running trajectory without contacting the roller, and configured to come into pressure contact with the contact member to generate a force to be exerted to the contact member when the elevator system is in a preset state such that the elevator car or counterweight stops in proximity to the preset position, the force at least reducing a contact pressure between the roller and the elevator guide rail.

### FOREIGN PRIORITY

This application claims priority to Chinese Patent Application No. 202411785732.6, filed Dec. 5, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, and in particular to an elevator roller pressure adjustment assembly and adjustment method, an elevator guide shoe, and an elevator system.

### BACKGROUND OF THE INVENTION

Various types of elevator equipment have been widely installed in many places such as high-rise buildings, stations, airports, private clubs, and family villas, which can greatly facilitate people's daily work, life, and travel. Rolling guide shoes are used in many elevator equipment to support the weight of an elevator car, and the rolling friction contact between the rollers in the rolling guide shoes and an elevator guide rail allows the elevator car to run along the elevator guide rail.

The configuration and usage condition of these rollers have an impact on the operational performance of an elevator system. For example, people usually use rollers with the characteristics of good wear resistance and low noise for elevator cars. For example, elastomers such as rubber and polytetrafluoroethylene can be wrapped around the roller body to reduce the frictional resistance and loss between the roller and the elevator guide rail, reduce the working noise during elevator operation, and avoid shaking of the elevator car during operation. However, the present application has found upon research that further optimization and improvement can be made to the elevator car rollers, rolling guide shoes, and other components in existing elevator systems, especially in application environments where the size of the top floor height and/or pit depth facing an elevator hoistway is relatively small, such as home lifts installed in private residences such as villas.

### SUMMARY OF THE INVENTION

In view of the foregoing, the present disclosure provides an elevator roller pressure adjustment assembly and adjustment method, an elevator guide shoe, and an elevator system, so as to solve or at least alleviate one or more of the aforementioned problems and other problems in the prior art, or to provide alternative technical solutions for the prior art.

According to one aspect of the present disclosure, an elevator roller pressure adjustment assembly is first provided, comprising: a contact member, fixed relative to at least one roller configured on an elevator car or counterweight, the roller being in rolling contact with an elevator guide rail and defining a running trajectory of the elevator car or counterweight along the elevator guide rail during normal operation of an elevator system; and a cooperating member, mounted at a preset position on the elevator guide rail and arranged outside the running trajectory without contacting the roller, and configured to come into pressure contact with the contact member to generate a force to be exerted to the contact member when the elevator system is in a preset state such that the elevator car or counterweight stops in proximity to the preset position, the force at least reducing a contact pressure between the roller and the elevator guide rail.

In an elevator roller pressure adjustment assembly according to the present disclosure, optionally, the contact member is configured not to contact with the elevator guide rail and have a first gap therebetween, and/or the force causes the roller to be out of contact with the elevator guide rail and a second gap is formed between the roller and the elevator guide rail.

In an elevator roller pressure adjustment assembly according to the present disclosure, optionally, a range of the first gap is 1-10 mm, and/or the second gap is not less than 1 mm.

In an elevator roller pressure adjustment assembly according to the present disclosure, optionally, the cooperating member is provided with different sections, and forces of different magnitudes are generated correspondingly when the contact member comes into contact with the different sections.

In an elevator roller pressure adjustment assembly according to the present disclosure, optionally, the cooperating member is provided with a first section, and a second section connected to the first section and arranged above the first section along a length direction of the elevator guide rail, a first force is generated when the contact member comes into contact with the first section and a second force is generated when the contact member comes into contact with the second section, the second force being greater than the first force.

In an elevator roller pressure adjustment assembly according to the present disclosure, optionally, the first section is configured with a guide portion having a cross-section gradually increasing towards a direction of the second section, and the second section is configured with a planar portion, a surface of the planar portion being parallel to a surface of the elevator guide rail, and the contact member comes into pressure contact with the second section when the elevator car or counterweight stops in proximity to the preset position.

In an elevator roller pressure adjustment assembly according to the present disclosure, optionally, the contact member is arranged above the roller along the length direction of the elevator guide rail, and the cooperating member is arranged at a first preset distance from a top of an elevator hoistway and/or the cooperating member is arranged at a second preset distance from a bottom of the elevator hoistway.

In an elevator roller pressure adjustment assembly according to the present disclosure, optionally, the elevator car or counterweight is configured with a first elevator guide shoe and a second elevator guide shoe which are arranged on a first side and a second side of the elevator guide rail respectively, the first elevator guide shoe being arranged above the second elevator guide shoe along the length direction of the elevator guide rail, the contact member is arranged in proximity to at least one roller in the first elevator guide shoe and/or at least one roller in the second elevator guide shoe, and the cooperating member is arranged correspondingly on the first side and/or the second side to be in pressure contact with corresponding contact member to generate the force.

In an elevator roller pressure adjustment assembly according to the present disclosure, optionally, the contact member is connected to a support shaft of the roller or to a bracket for fixing the roller, the contact member including a rolling component.

In an elevator roller pressure adjustment assembly according to the present disclosure, optionally, a distance between the preset position and a top or bottom of an elevator hoistway is not less than 1 m, and/or the preset state includes an idle state and an out-of-service state.

Secondly, according to another aspect of the present disclosure, an elevator guide shoe is also provided, which is used for an elevator car or counterweight, and comprises a base, rollers mounted on the base, and a contact member fixed relative to at least one of the rollers, the roller is in rolling contact with an elevator guide rail and defines a running trajectory of the elevator car or counterweight along the elevator guide rail during normal operation of an elevator system; when the elevator system is in a preset state such that the elevator car or counterweight stops in proximity to a preset position on the elevator guide rail, the contact member comes into pressure contact with a cooperating member mounted at the preset position and arranged outside the running trajectory without contacting the roller, to generate a force and bears the force, the force at least reducing a contact pressure between the roller and the elevator guide rail.

In an elevator guide shoe according to the present disclosure, optionally, the contact member is configured not to contact with the elevator guide rail and have a gap therebetween; and/or, the cooperating member is configured to disengage the roller from contact with the elevator guide rail through the force, thereby forming a gap between the roller and the elevator guide rail; and/or, the contact member is connected to a support shaft of the roller or to a bracket for fixing the roller, the contact member including a rolling component.

In addition, according to yet another aspect of the present disclosure, an elevator system is further provided, which comprises an elevator roller pressure adjustment assembly according to any of the above.

Furthermore, according to still another aspect of the present disclosure, an elevator roller pressure adjustment method is still further provided, comprising the steps of: configuring an elevator roller pressure adjustment assembly according to any of the above in an elevator system; and stopping an elevator car or counterweight in proximity to a preset position of the cooperating member on an elevator guide rail when the elevator system is in a preset state such that the cooperating member comes into pressure contact with the contact member to generate a force to be exerted to the contact member, thereby at least reducing the contact pressure between the roller and the elevator guide rail through the force.

In the elevator roller pressure adjustment method according to the present disclosure, optionally, the preset state includes an idle state and an out-of-service state; and/or generating forces of different magnitudes correspondingly by the contact member contacting with different sections on the cooperating member, when the elevator car or counterweight stops in proximity to the preset position on the elevator guide rail; and/or forming a gap between the roller and the elevator guide rail, by disengaging the roller from contact with the elevator guide rail through the force.

By configuring and using the elevator roller pressure adjustment assemblies and guide shoes according to the present disclosure in an elevator system, the rollers used for the elevator car or counterweight can be effectively protected, avoiding or alleviating deformation or damage to the rollers caused by pressure between the rollers and the elevator guide rail, especially the static pressure, and thus reducing the effects of vibration, impact, and noise. Therefore, the operating performance and safety reliability of the elevator system can be improved and the comfort of riding the elevator can be enhanced. The solutions according to the disclosure are easy to implement and low in cost, and are applicable to various application scenarios, such as home lifts, public elevators, and the like.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt an embodiment of an elevator roller pressure adjustment assembly according to the present disclosure.

FIG. 2 is a lateral cross-sectional structural schematic diagram of an example of an elevator car, in which two elevator guide shoes and a part of the elevator guide rail structure mounted on the left side of the elevator car are also shown from a left-side frontal view angle, without the configuration of an elevator roller pressure adjustment assembly according to the present disclosure.

FIG. 3 is a partial structural schematic diagram of mounting an embodiment of an elevator roller pressure adjustment assembly according to the present disclosure onto the elevator guide shoes and elevator guide rail in the example of the elevator car shown in FIG. 2.

FIG. 4 is a schematic diagram of the processing steps of an embodiment of an elevator roller pressure adjustment method according to the present disclosure.

### DETAILED DESCRIPTION OF THE INVENTION

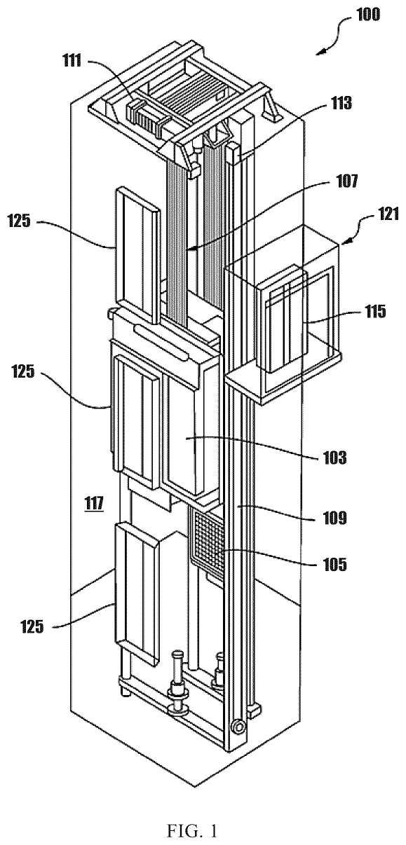

FIG. 1 is a perspective view of an elevator system 100 including an elevator car 103, a counterweight 105, a tension member 107, a guide rail (or rail system) 109, a machine (or machine system) 111, a position reference device 113, and an electronic elevator controller (controller) 115. The elevator car 103 and counterweight 105 are connected to each other by the tension member 107, and travel along the elevator hoistway 117 under the action of driving force. The tension member 107 may include, for example, steel belts (such as coated-steel belts) and/or ropes (such as steel cables). The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111. The machine 111 is configured to control movement between the elevator car 103 and the counterweight 105. Machine 111 may include a motor or similar power unit to provide driving force to elevator system 100, which may adopt a machine-room-less configuration. The position reference device 113 may be arranged in other positions and/or configurations known in the art, such as being mounted on a fixed part at the top of the elevator hoistway 117, such as on a crossbeam. The position reference device 113 may be configured to provide position signals related to a position of the elevator car and/or counterweight within the elevator hoistway. The position reference device 113 can employ any device or mechanism for monitoring a position of an elevator car and/or counterweight, as known in the art. For example, it includes but is not limited to an encoder, a sensor, or other component, and may include speed sensing, absolute position sensing, and the like.

The controller 115 may be located in a controller room 121 of the elevator hoistway 117 and may be configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference device 113 or any other desired device or system of this kind. When moving up or down within the elevator hoistway 117 along guide rail 109, the elevator car 103 may stop at one or more landings 125 as controlled by the controller 115. Although shown in a controller room 121, those skilled in the art will appreciate that the controller 115 can be located and/or configured in other locations or positions within the elevator system 100, such as located remotely or in the cloud.

Although specific elevators and components are shown and described herein, FIG. 1 is merely a non-limiting example presented for illustrative and explanatory purposes. It should be noted that other elevator systems can be configured to use the elevator roller pressure adjustment assemblies and elevator guide shoes disclosed herein, such as for home lifts, public elevators, and other occasions. Additionally, for the sake of simplifying the drawing, identical or similar components and features may only be indicated in one or several locations within the same drawing. Technical terms such as “first”, “second” are only used for the purpose of distinguishing and are not intended to indicate the order and relative importance thereof. The technical term “connect” (or “engage”) means the realization of connection (or engagement) in a direct or an indirect manner.

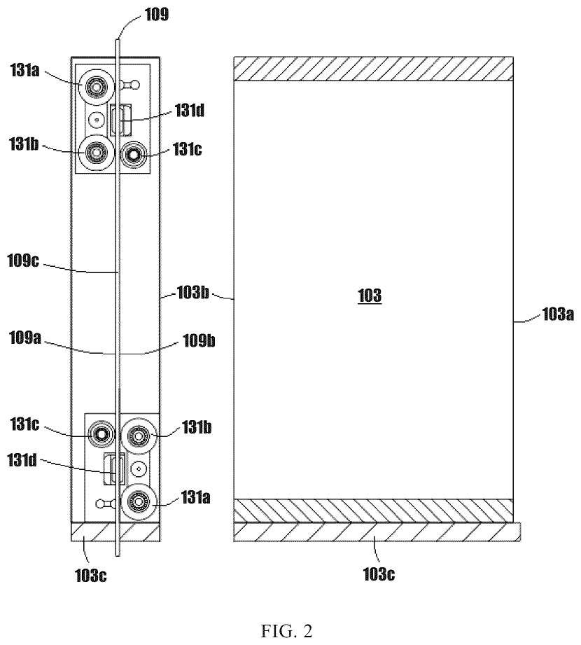

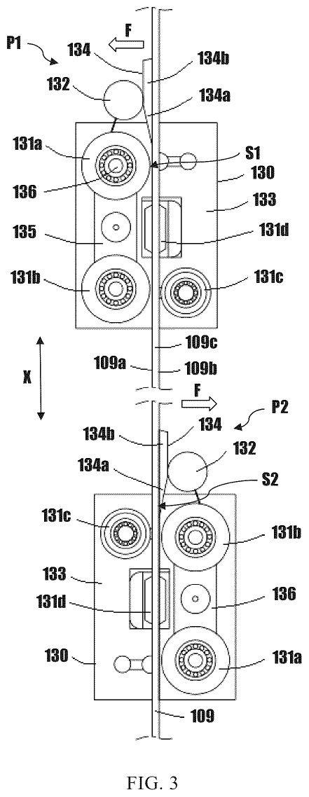

Referring to FIGS. 2 and 3 in conjunction and in comparison, a lateral cross-sectional structure of an example of an elevator car is shown in a schematic way in FIG. 2. At the same time, the elevator guide shoes and a part of an elevator guide rail structure mounted on that side are shown from a left-side frontal view angle, where the elevator roller pressure adjustment assembly according to the present disclosure is not configured. FIG. 3 shows, in a schematic way, the situation of a partial structure after an embodiment of the elevator roller pressure adjustment assembly is mounted onto the example of the elevator car and guide rail shown in FIG. 2.

Specifically, in the example shown in FIG. 2, guide shoe structures with several rollers can be mounted at the upper and lower positions of the side portion 103b of the elevator car 103. For example, the guide shoe located in the lower part can be mounted onto the lower frame 103c of the elevator car 103. When the elevator car 103 is running, the rollers in these guide shoes can be used to be in rolling friction with the elevator guide rail 109, thereby defining the running trajectory of the elevator car 103 along the elevator guide rail 109. Compared with sliding friction, the use of rolling friction is more conducive to reducing friction loss, improving running speed, and reducing vibration and noise during elevator operation.

As an optional embodiment, the two examples of guide shoe structure in FIG. 2 are configured with rollers 131a, 131b, 131c, and 131d, wherein rollers 131a and 131b, as well as roller 131c, can be arranged on the first side 109a and the second side 109b of the elevator guide rail 109, respectively, and roller 131d can be arranged to correspond to the outer end 109c of the elevator guide rail 109 facing the elevator hoistway 117. That is, during the operation of the elevator car 103, these rollers can be in rolling friction with the elevator guide rail 109 on the above three guide rail surfaces, and achieve smooth guiding and support functions. As shown in FIG. 2, the upper and lower elevator guide shoes can be arranged in a relatively inverted manner to form a structure commonly known as the “backpack type”. This kind of elevators with the backpack structure are often used for, for example, home lifts, private club elevators, and many other occasions, due to the advantages of relatively simple configuration, space saving, easy installation, and low cost.

As appreciated by those skilled in the art, elevator rollers are prone to problems such as wear, vibration, and noise during friction with guide rails. Therefore, various methods have been commonly used in the prior art to solve or alleviate such problems, such as selecting suitable materials for elevator rollers, optimizing and improving structures, and the like. For example, most elevator rollers in the prior art are configured with elastic outer layers made of materials such as polytetrafluoroethylene and rubber for contact with elevator guide rails, which can significantly alleviate problems such as wear, vibration, noise, etc., making such problems less prominent and difficult to notice or feel in actual use, or even completely non-existent in terms of sensation.

The present application, after research, has found and noticed that there are some aspects that can be improved for elevator rollers for use in elevator cars and/or counterweights, especially when the rollers come into contact with elevator rails, such as when the elevator stops running for a long time (such as more than 10 minutes, 30 minutes, or 60 minutes, which is related to the specific pressure resistance performance of the materials and structures used for the elevator rollers, the material properties of the elevator guide rails, etc.). Due to the contact pressure between the elevator rollers and the guide rails, concave deformations may occur at the contact points. When the elevator runs again, these local deformations may bring undesired effects, such as car shaking of the elevator car, operating noise, and the like. However, with the operation and use of the elevator, due to the continuous rolling friction between the elevator rollers and the guide rails, the elevator rollers tend to recover and maintain roundness, causing other parts of the rollers to reform a round or basically round state together with the parts that have already undergone local deformations. This will quickly eliminates the shaking, noise, and other phenomena caused by local deformations, so that users will not notice the deformation problems that previously occurred to the elevator rollers, or even if they briefly notice the above phenomena, they will not realize the existence of abnormal situations due to their rapid disappearance, resulting in the inability to clearly recognize the possible problems that may exist in the elevator rollers.

According to the solutions of the present disclosure, an elevator roller pressure adjustment assembly can be configured for the elevator system to solve or at least alleviate such problems. It should be pointed out that the following description for the elevator roller pressure adjustment assembly used on the elevator car side can also be used on the counterweight side, which therefore will not be repeated.

As an example, as used herein, the pressure adjustment operation for the elevator roller can be achieved by arranging a contact member 132 and a cooperating member 134. Firstly, referring to the upper guide shoe structure in FIG. 3, the contact member 132 can be fixed relative to the roller 131a in the elevator guide shoe 130. For example, the contact member 132 can be connected to the support shaft 136 of the roller 131a, or it can be connected to the bracket 135 or any other suitable structure used to fix the roller 131a in place on the elevator guide shoe 130, so that the contact member 132 and the roller 131a can be relatively fixed and their linkage can be achieved. As for the contact member 132, it can be designed with any feasible structure, shape and size as needed. For example, it can be in the form of rolling components such as bearings, and any feasible methods such as welding or detachable connections (such as bolts, screws, etc.) can be used to mount the contact member 132 in place. The contact member 132 can selected to be made of one, two or more materials as needed. For example, in some applications, rigid materials such as steel and iron can be used alone, while in other applications, elastic or plastic materials can be fully or partially wrapped around the exterior of the structure composed of rigid materials.

When the elevator system 100 is operating normally, the contact member 132 may not be in contact with the elevator guide rail 109. This is because during installation, the contact member 132 can be arranged to maintain a preset gap with the elevator guide rail 109. The specific value of this gap can be set or adjusted according to actual application requirements, for example, it can be optionally set within the range of 1-10 mm, such as 2 mm, 3 mm, 4 mm, 5 mm, 8 mm, etc., any value that meets specific application requirements. In one or some embodiments, the contact member 132 can also be arranged to be in contact with the elevator guide rail 109 during normal operation of the elevator system 100, thereby providing partial support through it.

The cooperating member 134 is arranged on the elevator guide rail 109 for coordinated use with the contact member 132, so as to achieve the purpose of disengaging the roller 131a from the elevator guide rail 109, or reducing the contact pressure between them compared to when the elevator roller pressure adjustment assembly was not originally configured, when needed.

Specifically, referring to the upper guide shoe structure in FIG. 3, the cooperating member 134 can be mounted at the preset position P1 on the elevator guide rail 109 by welding or detachable connection (such as bolts, screws, etc.). For example, the distance between the preset position P1 and the top of the elevator hoistway 117 should not be less than a preset value, such as 1 m or any other suitable value. In addition, the preset position P1 is arranged outside the running trajectory of the elevator car 103 on the elevator guide rail 109, so the cooperating member 134 does not come into contact with the roller 131a. As such, in the case where the application requirements are met, for example, when the elevator system 100 is currently in an idle state (e.g., exceeding a time period that can be set as needed, such as 10 minutes, 20 minutes, or other values), or in an out-of-service state (e.g., when the elevator system receives a stop instruction from the operator, or enters a pre-set time point, such as from dawn to 6 a.m., etc.), the elevator car 103 can be operated to stop near the preset position P1 in such a preset state. At this point, the contact member 132 can come into contact and press against the cooperating member 134, thereby generating a force F that acts on the contact member 132. As mentioned earlier, as the contact member 132 and the roller 131a are relatively fixed, the aforementioned force F will be transmitted to the roller 131a through the contact member 132, thereby causing the roller 131a to move in a direction away from the elevator guide rail 109. For example, the roller 131a (FIG. 2), which was originally pressed against and in contact with the elevator guide rail 109 and subjected to pressure, can now be released from contact with the elevator guide rail 109, or the contact pressure between it and the elevator guide rail 109 can be reduced compared to the situation shown in FIG. 2, i.e., at least alleviating the adverse effects of local deformation caused by static pressure on the roller 131a when the elevator car is in an out-of-service state.

When the roller 131a comes out of contact with the elevator guide rail 109 by a force F generated by the coordinated contact between the cooperating member 134 and the contact member 132, a gap can be formed between them. At this point, the contact member 132 will bear the contact pressure between the cooperating member 134 and the elevator guide rail 109, effectively protecting and avoiding local deformation of the roller 131a. In FIG. 3, the above gap has been indicated with reference sign S1, which can be optionally controlled to be greater than or equal to 1 mm.

According to different application requirements, the cooperating member 134 and the contact member 132 can be designed and configured accordingly to achieve different pressure adjustment effects on the elevator rollers. For example, differentiated forces F can be generated. For example, these forces may have different magnitudes and have different effects on the displacement movement of the elevator rollers relative to the elevator guide rail.

For example, the cooperating member 134 can be composed of two, three, or more different sections, so that forces F of different magnitudes may be generated accordingly when the contact member 132 comes into contact with these different sections. For example, as used in the example of FIG. 3, the cooperating member 134 can be optionally configured to have a first section 134a and a second section 134b, which can be arranged along the length direction X of the elevator guide rail 109. When using this pressure adjustment assembly, if the contact member 132 comes into contact with the first section 134a of the cooperating member 134, a first force will be generated, and if the contact member 132 comes into contact with the second section 134b of the cooperating member 134, a second force will be generated, which may be greater than the first force. As such, as an optional scenario, by designing the magnitudes of the first and second forces accordingly, it is possible to control the different contact conditions between the roller 131a and the elevator guide rail 109, in order to better achieve different desired effects. For example, a relatively small gap can be maintained under the first force, and a relatively large gap can be maintained under the second force. Considering that the roller 131a may continuously wear out during long-term use, it is very advantageous to adaptively and flexibly adjust and provide the required gap S1.

Continuing with the example, as shown in FIG. 3, the first section 134a can be configured with a guide portion in the shape of, for example, a wedge, which can have a gradually increasing cross-section towards the direction of the second section 134b, in order to more smoothly guide the contact member 132 to be in pressure contact with the cooperating member 134. In addition, the second section 134b can be configured with a planar portion that is parallel to the surface of the elevator guide rail 109. In this way, when the elevator car 103 runs close to the preset position P1 of the cooperating member 134 and finally stops, the contact member 132 can first come into contact with the first section 134a, and then remain in pressure contact with the second section 134b. At this point, the force F generated can be stably transmitted to the contact member 132, and then transmitted to the roller 131a to move it in a direction away from the elevator guide rail 109, for example, in a state of remaining a gap S1 from the elevator guide rail 109, thereby avoiding the situation where the contact part that can cause the roller 131a to face the elevator guide rail 109 and bear pressure is recessed and deformed.

The upper guide shoe structure in FIG. 3 is described above as an example. It should be appreciated that these situations described are also applicable to the lower guide shoe structure in FIG. 3. For example, the corresponding cooperating member 134 can be arranged at the preset position P2 on the elevator guide rail 109, where the preset position P2 is correspondingly configured and used with the aforementioned preset position P1. That is, when the contact member 132 and the cooperating member 134 used for the upper guide shoe structure form a pressure contact, the contact member 132 and the cooperating member 134 used for the lower guide shoe structure also form a pressure contact, thereby simultaneously achieving positive and beneficial technical effects of avoiding or alleviating the deformation of the contact surface of the roller 131b in the lower guide shoe structure due to pressure.

It should be noted that although, as shown in FIG. 3, pressure adjustment assemblies are correspondingly configured for both the upper and lower guide shoe structures, in one or some embodiments, however, the pressure adjustment assembly may only be configured for one of the guide shoe structures. For example, a pressure adjustment assembly can be configured only for the guide shoe structure located at the lower part of the elevator car. For example, the cooperating member 134 therein can be arranged at a preset distance from the bottom of the elevator hoistway 117 (such as 1 meter or any other suitable value), so that when the elevator car 103 is made to stop close to the mounting position P2 of the cooperating member 134 when needed, a force F can be generated by the pressure contact between the cooperating member 134 and the contact member 132, which can cause the roller 131b to be out of contact with the elevator guide rail 109 or reduce the contact pressure between them. It should be pointed out that the gap S2 formed between the roller 131b and the elevator guide rail 109 after they disengage from contact with each other can have the same or different dimensions as the gap S1 discussed above, as long as they meet their specific requirements.

The present disclosure also provides elevator guide shoes that are different from existing designs, which can be configured with contact members as discussed above. In FIG. 3, two specific examples are given. The elevator guide shoe 130 may comprise a base 133, rollers 131a, 131b, 131c, and 131d, and a contact member 132. These rollers are mounted on the base 133. The contact member 132 is arranged adjacent to and connected to the roller 131a in the upper guide shoe 130 or the roller 131b in the lower guide shoe 130, for generating a force F by operating in coordination with the cooperating member 134 when needed. The force F can help to eliminate or reduce the contact pressure between the roller 131a or 131b and the elevator guide rail 109, thereby protecting the target roller from local deformation caused by pressure and thus alleviating adverse situations such as accelerated wear.

The elevator guide shoe according the present disclosure is not limited to the structural configuration of the embodiment shown in FIG. 3. Those skilled in the art can reduce or add any suitable components according to actual requirements in different application scenarios. For example, in some cases, only one roller may be configured, or more roller assemblies may be formed. These changes are all allowed. Contact members can be correspondingly configured for one or more rollers in the elevator guide shoe of the present disclosure according to specific requirements, and cooperating members as discussed above can be arranged at corresponding positions on the elevator guide rail to operate in coordination with this contact member or these contact members. In addition, one, two, or more of the elevator guide shoes according to the present disclosure can be configured and used as needed in the elevator system. For example, as shown in FIG. 2, in one or some embodiments, one or more of the elevator guide shoes can also be mounted on the other side 103a of the elevator car 103. Although forming a symmetrical arrangement of the elevator guide shoes on the sides 103a and 103b of the elevator car 103 is beneficial for overall balance, in one or some embodiments, however, they may also be arranged asymmetrically, or one or more elevator guide shoes provided by the prior art can be used in combination. The present disclosure makes no restrictions in this regard.

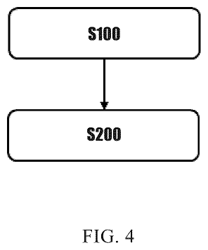

Referring now to FIG. 4, the basic steps of an elevator roller pressure adjustment method according to the present disclosure are shown. In the embodiment of the method, it may comprise the following steps:

In step S100, an elevator roller pressure adjustment assembly according to the present disclosure can be configured in the elevator system to protect the desired elevator rollers, so as to avoid or alleviate potential local deformation that may cause undesired damage to the roller structure, vibration of the elevator car or counterweight that may cause noise and thus affect elevator comfort, and other problems. The composition, use, advantages, and other aspects of the elevator roller pressure adjustment assembly have been discussed in detail in combination with specific examples in the previous text.

In step S200, the elevator car or counterweight can stop close to a preset position where the cooperating member of the elevator roller pressure adjustment assembly is mounted on the elevator guide rail, so that the cooperating member can come into pressure contact with the contact member to generate a force that is exerted to the contact member. The force is then transmitted to the elevator rollers, so that the contact pressure between the elevator rollers and the elevator guide rail can be eliminated or reduced.

Those skilled in the art can appreciate that technical contents such as the configuration, installation, and use of the roller pressure adjustment assembly and elevator guide shoe have been described in detail in the previous text. For example, when the elevator system enters a preset state (such as an idle state, an out-of-service state, etc., which can be detected or judged by, for example, the controller 115, etc.), the elevator car or counterweight can be driven to stop in proximity to a preset position of the cooperating member on the elevator guide rail, so as to adjust the current contact pressure between the elevator rollers and the elevator guide rail, thereby eliminating or reducing it. For another example, by making contact between the contact member and different sections of the cooperating member, forces F of different magnitudes can be generated accordingly to meet the needs of different application scenarios. For yet another example, by applying a force F, one or more target rollers desired to be protected can be completely out of contact with the elevator guide rail, thereby forming a gap between them. Therefore, more possible steps and configurations of the method of the present disclosure can be formed by directly referring to the specific descriptions and contents of the corresponding parts mentioned above, which will not be repeated here.

The elevator roller pressure adjustment assemblies and adjustment methods, elevator guide shoes, and elevator systems according to the disclosure have been described above in detail by way of examples only. These examples are merely used to illustrate the principles and embodiments of the disclosure, rather than limiting the disclosure. Various modifications and improvements can be made by those skilled in the art without departing from the scope of the disclosure. Therefore, all equivalent technical solutions should fall within the scope of the disclosure and be defined by the claims of the disclosure.

What is claimed is:

1. An elevator roller pressure adjustment assembly, comprising:
a contact member, fixed relative to at least one roller configured on an elevator car or counterweight, the roller being in rolling contact with an elevator guide rail and defining a running trajectory of the elevator car or counterweight along the elevator guide rail during normal operation of an elevator system; and
a cooperating member, mounted at a preset position on the elevator guide rail and arranged outside the running trajectory without contacting the roller, and configured to come into pressure contact with the contact member to generate a force to be exerted to the contact member when the elevator system is in a preset state such that the elevator car or counterweight stops in proximity to the preset position, the force at least reducing a contact pressure between the roller and the elevator guide rail.

2. The elevator roller pressure adjustment assembly according to claim 1, wherein the contact member is configured not to contact with the elevator guide rail and have a first gap therebetween, and/or the force causes the roller to be out of contact with the elevator guide rail and a second gap is formed between the roller and the elevator guide rail.

3. The elevator roller pressure adjustment assembly according to claim 2, wherein a range of the first gap is 1-10 mm, and/or the second gap is not less than 1 mm.

4. The elevator roller pressure adjustment assembly according to claim 1, wherein the cooperating member is provided with different sections, and forces of different magnitudes are generated correspondingly when the contact member comes into contact with the different sections.

5. The elevator roller pressure adjustment assembly according to claim 4, wherein the cooperating member is provided with a first section, and a second section connected to the first section and arranged above the first section along a length direction of the elevator guide rail, a first force is generated when the contact member comes into contact with the first section and a second force is generated when the contact member comes into contact with the second section, the second force being greater than the first force.

6. The elevator roller pressure adjustment assembly according to claim 5, wherein the first section is configured with a guide portion having a cross-section gradually increasing towards a direction of the second section, and the second section is configured with a planar portion, a surface of the planar portion being parallel to a surface of the elevator guide rail, and the contact member comes into pressure contact with the second section when the elevator car or counterweight stops in proximity to the preset position.

7. The elevator roller pressure adjustment assembly according to claim 1, wherein the contact member is arranged above the roller along the length direction of the elevator guide rail, and the cooperating member is arranged at a first preset distance from a top of an elevator hoistway and/or the cooperating member is arranged at a second preset distance from a bottom of the elevator hoistway.

8. The elevator roller pressure adjustment assembly according to claim 7, wherein the elevator car or counterweight is configured with a first elevator guide shoe and a second elevator guide shoe which are arranged on a first side and a second side of the elevator guide rail respectively, the first elevator guide shoe being arranged above the second elevator guide shoe along the length direction of the elevator guide rail, the contact member is arranged in proximity to at least one roller in the first elevator guide shoe and/or at least one roller in the second elevator guide shoe, and the cooperating member is arranged correspondingly on the first side and/or the second side to be in pressure contact with corresponding contact member to generate the force.

9. The elevator roller pressure adjustment assembly according to claim 1, wherein the contact member is connected to a support shaft of the roller or to a bracket for fixing the roller, the contact member including a rolling component.

10. The elevator roller pressure adjustment assembly according to claim 1, wherein a distance between the preset position and a top or bottom of an elevator hoistway is not less than 1 m, and/or the preset state includes an idle state and an out-of-service state.

11. An elevator guide shoe for an elevator car or counterweight, comprising a base, rollers mounted on the base, and a contact member fixed relative to at least one of the rollers, the roller is in rolling contact with an elevator guide rail and defines a running trajectory of the elevator car or counterweight along the elevator guide rail during normal operation of an elevator system; when the elevator system is in a preset state such that the elevator car or counterweight stops in proximity to a preset position on the elevator guide rail, the contact member comes into pressure contact with a cooperating member mounted at the preset position and arranged outside the running trajectory without contacting the roller, to generate a force and bears the force, the force at least reducing a contact pressure between the roller and the elevator guide rail.

12. The elevator guide shoe according to claim 11, wherein the contact member is configured not to contact with the elevator guide rail and have a gap therebetween; and/or, the cooperating member is configured to disengage the roller from contact with the elevator guide rail through the force, thereby forming a gap between the roller and the elevator guide rail; and/or, the contact member is connected to a support shaft of the roller or to a bracket for fixing the roller, the contact member including a rolling component.

13. An elevator system, comprising an elevator roller pressure adjustment assembly according to claim 1.

14. An elevator roller pressure adjustment method, comprising steps of:
configuring an elevator roller pressure adjustment assembly according to claim 1 in an elevator system; and
stopping an elevator car or counterweight in proximity to a preset position of the cooperating member on an elevator guide rail when the elevator system is in a preset state such that the cooperating member comes into pressure contact with the contact member to generate a force to be exerted to the contact member, thereby at least reducing the contact pressure between the roller and the elevator guide rail through the force.

15. The elevator roller pressure adjustment method according to claim 14, wherein the preset state includes an idle state and an out-of-service state; and/or
generating forces of different magnitudes correspondingly by the contact member contacting with different sections on the cooperating member, when the elevator car or counterweight stops in proximity to the preset position on the elevator guide rail; and/or
forming a gap between the roller and the elevator guide rail, by disengaging the roller from contact with the elevator guide rail through the force.
